(19) United States
(12) Patent Application Publication
(10) Pub. No.: US 2017/0108209 A1
(43) Pub. Date: Apr. 20, 2017

(54) EVAPORATOR

(71) Applicant: BSH Hausgeräte GmbH, Munich (DE)

(72) Inventors: Dieter Lego, Karlsruhe (DE); Martin Nagel, Forstheim (DE); Benjamin Wagner, Bretten (DE)

(21) Appl. No.: 15/315,794

(22) PCT Filed: Jun. 3, 2015
(86) PCT No.: PCT/EP2015/062323

§ 371 Date: Dec. 2, 2016

(30) Foreign Application Priority Data
Jun. 5, 2014 (DE) 10 2014 210 670.2

(51) Int. Cl. F22B 1/28; G01F 23/26

(52) U.S. Cl. CPC F22B 1/284; G01F 23/26

(57) ABSTRACT

An evaporator for a household appliance includes a housing wall configured to delimit a receiving space for a liquid to be evaporated, and an electrical heating unit for heating the liquid. A fill level sensor is arranged on an exterior face of the housing wall and configured to determine a fill level of the liquid in the receiving space. The fill level sensor operates in a contactless manner and generates an electromagnetic field in the receiving space.

The invention relates to an evaporator for a household appliance, having a receiving space for liquid to be evaporated with an electrical heating unit and a fill level sensor for determining a fill level of the liquid in the receiving space. The invention further relates to a household appliance having such an evaporator. The invention can be applied particularly advantageously to cooking appliances, namely as individual appliances or combination appliances.

DE 10 2007 001 175 A1 discloses a method and an apparatus for measuring the fill level of aggressive media in a tank, in particular a urea solution for the after-treatment of exhaust gas in an internal combustion engine. To create a cost-effective and reliably operating method of measuring the fill level of aggressive media and a corresponding apparatus, it is proposed that the apparatus has a facility for capacitative fill level measurement, which is embodied to measure the liquid level through a wall of a respective tank and to be connected to an evaluation circuit.

DE 10 2008 035 635 A1 discloses an apparatus for capacitative measurement of a fill level or a level of a medium with an elongated sensor for generating an electrical field. To this end the sensor has at least two elongated electrodes, which are provided for arrangement outside of the medium and are suitable for generating an electrical field which passes through the medium at least in sections. One conceivable use is to measure the fill level in plastic containers for instance.

EP 2 400 275 A1 discloses an apparatus for non-invasive capacitative fill level measurement of a filling medium in a container, said apparatus having a) at least two measuring electrodes which are arranged at different horizontal levels and a measuring surface with a vertical extent, and b) at least one reference electrode, which defines a reference surface with a vertical extent, wherein each measuring electrode together with the reference electrode embodies a capacitor in each case, as a result of which an electrical field can be embodied in each case, wherein the vertical extent of the reference surface corresponds at least to the vertical extent of the measuring surface.

It is the object of the present invention to overcome the disadvantages of the prior art at least partially and in particular to provide a simply constructed and low-maintenance evaporator of a steam treatment device, in particular for household appliances, in particular for cooking appliances.

This object is achieved according to the features of the independent claims. Preferred embodiments can be inferred in particular from the dependent claims.

The object is achieved by an evaporator for a household appliance, having a receiving space for liquid to be evaporated with an electrical heating unit for heating the liquid and a fill level sensor for determining a fill level of the liquid in the receiving space, wherein the fill level sensor is a sensor which operates in a contactless manner and generates an electromagnetic (i.e. an electrical and/or magnetic) field in the receiving space, said sensor being arranged on an exterior face of a housing wall which delimits the receiving space.

It has surprisingly been shown that the fill level of a boiling or almost boiling liquid with a moving surface, such as typically occurs in an evaporator, can also be sufficiently accurately determined by means of the fill level sensor which operates in a contactless manner This has the advantage that the fill level sensor does not come into direct contact with the heated liquid and is thus particularly long-lasting. In particular, the fill level sensor arranged on the outside is not exposed to any corrosion due to the hot liquid. The fill level sensor is also not able to calcify, which improves the long term stability of the measurement. Furthermore, there is no problem when sealing the fill level sensor from the receiving space. Such a fill level sensor does not need to be cleaned, e.g. descaled and generally also not replaced.

The receiving space for liquid to be evaporated may also be referred to as an evaporator space or steam generation chamber. It can be filled with liquid, in particular water, and to this end has at least one liquid entry or liquid supply opening. It also has at least one steam outlet opening for discharging the steam generated from the liquid with its help. The receiving space may also be drained of liquid. To this end it may have a separate drain opening, or the liquid is supplied and discharged or drained through the same opening. The receiving space is preferably filled with fresh water, while, if necessary, drained liquid can be regarded as waste water for instance.

In one embodiment the fill level sensor is a capacitative sensor. This permits a particularly accurate fill level measurement, namely also with a boiling liquid with a low fill level, e.g. in the range of only a few millimeters. The fill level sensor generates an electrical field. To this end the capacitative fill level sensor may have one or a number of measuring electrodes and at least one ground electrode for instance. The capacitative fill level sensor may be embodied similarly to DE 10 2007 001 175 A1, DE 10 2008 035 635 A1 or EP 2 400 275 A1 for instance.

In another embodiment the fill level sensor is an inductive sensor. The fill level sensor generates a magnetic field, in particular a magnetic alternating field. To this end the inductive fill level sensor may have one or a number of coils or antennae. The mode of operation of inductive fill level sensors is essentially known and does not need to be detailed further here.

In one development the housing wall, on which the fill level sensor is arranged, is a side wall of the housing, in particular a vertical side wall. In particular, a capacitative fill level sensor may then be arranged in an area of the housing which, during normal operation of the evaporator, can be wetted on the inside at least partially by the liquid. This thus permits a particularly strong measuring signal. This area of the housing is in particular at least partially lower than a maximum fill level of the liquid in the housing.

In one development, the housing wall is a ceiling or ceiling-side wall of the housing, in particular for arranging an inductive fill level sensor.

The material of the housing wall preferably has a low permittivity for an accurate fill level measurement. The material of the housing wall, at least in the area of the fill level sensor, may to this end be in particular a non-metallic material, e.g. plastic.

The fill level sensor may in particular have an electronic circuit for its operation. The fill level sensor may comprise e.g. an integrated circuit such as a microprocessor, a microcontroller, an ASIC, an FPGA etc. In particular, one or a number of measuring elements (electrodes, antennae etc.) may be arranged on the side of a printed circuit board or circuit board which faces the housing wall, while the electronic circuit is arranged on the side of the circuit board which faces away from the housing wall.

In yet another embodiment, the electrical heating unit is a large-surface heating element, which represents a floor of the receiving space. The large-surface heating element is advantageous in that the liquid disposed in the receiving space for steam generation can easily be heated up on a large-scale and thus particularly quickly. A fill level of the liquid in the receiving space may only be minimal, e.g. in the range of millimeters, e.g. between eight and ten millimeters, e.g. nine millimeters, which further assists with a rapid heating-up and permits a flat design. The large-surface heating element therefore preferably forms a floor-side wall of the receiving space. It is also referred to below as “floor-side large-surface heating element”.

In yet another embodiment, the large-surface heating element has at least one unheated zone and the fill level sensor is arranged on the unheated zone. As a result, the liquid volume sensed by the fill level sensor is not agitated directly by the large-surface heating element in the vicinity of the housing wall. In particular, a formation of bubbles above the unheated zone is suppressed. This improves measurement accuracy. The fact that the fill level sensor is arranged on the unheated zone may in particular mean that the area of the housing wall (in particular side wall) on which the fill level sensor is arranged is arranged bordering the unheated zone or adjacent to the unheated zone or bordering a still area of the liquid or adjacent to a still area of the liquid.

In yet another embodiment the unheated zone corresponds to a boundary area, in particular corner area, of the large-surface heating element. This facilitates a capacitive fill level measurement for instance, in which practically only one still area of the liquid disposed above the unheated zone is sensed.

In a further embodiment, at least one wall (referred to below, without restricting the generality, as “separating wall”) extends into a volume above the unheated zone of the large-surface heating element and which can be filled by the liquid. The at least one separating wall is therefore embodied on an interior face of the housing. As a result, a transmission of a movement of the surface of the liquid above a heated zone into the area of the liquid above the unheated zone when the large-surface heating element is switched on is suppressed. The liquid above the unheated zone or in the still area is therefore agitated less, which again further improves the measurement accuracy.

The at least one separating wall is in particular a vertical wall. The separating wall does not need to be arranged on a boundary between the unheated zone and a heated zone of the large-surface heating element, but may, for instance, be arranged above the unheated zone at a lateral distance from the heated zone. This reduces a possible transfer of significantly agitated liquid in the still area of the liquid above the unheated zone.

In yet a further embodiment, at least one separating wall extends starting from a ceiling of the evaporator into the volume above the unheated zone of the large-surface heating element which can be filled by the liquid. This allows a particularly simple production.

In addition or alternatively, at least one separating wall may emanate from a side wall of the housing.

Above a maximum fill level, the at least one separating wall may be at least partially open or closed.

In a further embodiment a chamber which is disposed above the unheated zone and is at least open on the floor side is formed by means of the at least one separating wall, said chamber being embodied to fluidically communicate with the remaining receiving space (which has at least one heated zone). As a result, a surface movement of the liquid is particularly effectively suppressed. The available opening which in particular maintains a distance from the large-surface heating element enables the liquid to be exchanged sufficiently quickly between these two areas in order to allow for a real-time fill level measurement. The opening may in particular be embodied as a gap between the at least one separating wall and the floor-side large-surface heating element.

Moreover, in one development a steam outlet or the steam outlet opening is arranged above the unheated zone. This is advantageous in that no small water droplets are carried along with the flow of steam, which, by contrast, typically form on the agitated water above the heated zone. This improves the steam quality. The fewer water droplets there are in the flow of steam, the higher its energy content and thus the efficiency. Moreover, this prevents the food in the food treatment chamber from being damaged by the water droplets.

Moreover, in one embodiment the evaporator has a housing with a bottom piece and a cover piece and the receiving space is formed by the cover piece and the large-surface heating element. This permits simple assembly and maintenance of the evaporator. The fill level sensor may, in particular, be arranged on an exterior face of the cover. The at least one separating wall may be present in particular on an interior face of the cover, e.g. on a side wall and/or on a ceiling or ceiling wall.

In another embodiment a temperature sensor is arranged on the fill level sensor. This permits a temperature measurement of the fill level sensor and/or the liquid in a compact manner The temperature sensor may be arranged, for instance, on a side of the fill level sensor which faces away from the housing or on a side of the fill level sensor (in other words between the fill level sensor and housing) which faces the housing. The arrangement on the side of the fill level sensor which faces away from the housing avoids a shading of the electromagnetic field or the electromagnetic signals emitted through the housing by the fill level sensor and/or a simple design. The arrangement on the side of the fill level sensor which faces the housing permits a quicker response from the temperature sensor and a more accurate temperature measurement.

The temperature sensor may be an NTC for instance. If the fill level sensor is embodied by means of a circuit board, the temperature sensor can be arranged on this circuit board for instance. As a result, the electronic circuit can take into account the measuring signals of the temperature sensor directly during an evaluation and/or even upon actuation of the measuring elements.

Moreover in one embodiment the temperature sensor is connected to an evaluation facility for evaluation of the sensor signals of the fill level sensor. As a result, with a signal evaluation temperature-dependent component properties of the fill level sensor and/or a temperature dependency of the permittivity of the liquid can be taken into account and at least partially compensated.

In yet another embodiment, the temperature sensor is connected to a temperature setting facility for setting a temperature of the liquid and/or the large-surface heating element. The temperature setting facility may set a flow of heat through the large-surface heating element for instance. This embodiment permits the temperature of the liquid in the evaporator to be set and/or controlled, for instance in order to perform a descaling process. The temperature sensor can be used for instance to set or control the temperature of a descaling liquid. The descaler develops a better/faster cleaning effect at a higher temperature. The temperature should however also not be too high, since this may result in the descaler no longer having an effect.

In another development the large-surface heating element has a carrier plate which delimits the receiving space, at the rear of which facing away from the receiving space at least one heating conductor track is arranged. This development can be realized in a compact and robust manner The carrier plate may consist in particular of metal, e.g. a ferrous metal, e.g. from stainless steel. The carrier plate may be a sheet part for instance.

Particularly when embodying the carrier plate from electrically conductive material, this may also serve as an electrode, e.g. as a ground electrode, of a capacitative fill level sensor.

The carrier plate may be a flat plate at least in the non-heated state of the evaporator. The carrier plate may be uncoated or scaled on its front side which faces the receiving space for instance. The carrier plate may alternatively consist of ceramic for instance.

In order to achieve a particularly low thermal inertia and thus high energy yield at the same time as a good thermal conductivity and high robustness, the carrier plate has a thickness of between one and two millimeters, but is however not restricted thereto.

The at least one heating conductor track may for instance be a thin film heating conductor track or a thick-film heating conductor track and serve as an electrical resistance heating element. In particular, a thick-film heating conductor track can be produced particularly simply, cost-effectively and with high quality and is still very space-saving.

Particularly in the case of an electrically conductive carrier plate the at least one heating conductor track may be fastened by way of an electrical insulation layer to the carrier plate, in order to prevent a short-circuit. The large-surface heating element may be populated by a cover layer on its rear face which faces away from the receiving space, e.g. as protection against mechanical stress.

In one development the large-surface heating element has a thickness of between one and two millimeters. Moreover in one development the large-surface heating element has a number of planar heating conductor tracks which can be operated independently of one another. A particularly accurate grading of the heat output introduced can thus be easily reached (e.g. with a constant flow of heat and/or with a fixed pulsing of the flow of heat). In yet another development, at least two of the heating conductor tracks have a different nominal output or a different maximum output. This achieves a particularly accurate grading of the heat output introduced with a low number of heating conductor tracks.

In yet another development the evaporator has a seal which rests on the side edge. In particular, the convex side edge forms a receiving area or holding area for the seal in a particularly easily realizable manner, in particular together with the housing. The seal may be placed along the side edge of the large-surface heating element. The seal may have a cross-sectional shape and material composition which is similar to an O-ring, but, in the top view for instance, deviates from a circular ring shape. However, the type of seal is fundamentally not restricted, but may also be embodied as a flat seal for instance. Generally in one development, the seal is tightened by means of the side edge, which ensures its precise fit also under thermal deformation of the large-surface heating element. The seal may be held in particular by means of the housing and the side edge. In yet another development, the seal is a double seal with two sealing elements arranged one above the other, which rest on the top or bottom of the side edge. This allows a particularly secure seal to be achieved.

In yet another embodiment, the household appliance is a cooking appliance.

The object is also achieved by a household appliance, in particular cooking appliance, having an evaporator as described above. The household appliance may be a stand-alone appliance or may be a combination appliance. The household appliance is in particular a household appliance within the meaning of “white goods”.

In one development the household appliance is a food handling appliance. The household appliance to this end has a food treatment chamber which can be filled with steam from the evaporator. The food treatment appliance may be an oven with a steam cooker functionality for instance. Such an oven may be a single appliance or an oven/hob combination (cooker). The oven may, in particular, be a baking oven with a steam treatment function. Apart from use in a food treatment appliance the evaporator may also be used for instance in irons, coffee machines, cleaning appliances or washing machines.

The evaporator may be accommodated in the food treatment chamber, e.g. on the wall or floor side, or may be accommodated outside of the food treatment chamber.

In another development the household appliance has a filling facility for filling the evaporator and/or a drain facility for draining the evaporator. This permits a particularly precise dosing of liquid or an effective draining of the receiving space.

In yet another development, the filling facility and the drain facility are different functional units. As a result, the delivery characteristics can be attuned particularly precisely to the respective purpose. Therefore in another embodiment the filling facility and the drain facility have or are respective pumps.

In yet another development, the filling facility and the drain facility are fluidically separated from one another and to this end are in particular connected to fluid supply lines which are fluidically separated from one another. This can achieve a separation of a fresh-water area from a waste water area for instance.

Alternatively, a filling facility and a drain facility may be realized as a single combined filling and draining facility, e.g. with or as a single pump. The filling and draining can then be achieved by correspondingly positioning one or a number of valves of a line system connected at least section by section for the liquid.

The household appliance may have an overheating detector for establishing an overheating of the heating unit. In one development the large-surface heating element serves as the overheating detector. For instance, the large-surface heating element may have a temperature-dependent electrically conductive layer. Then a temperature of the large-surface heating element and therefore an overheating can be determined by establishing a conductivity or corresponding electrical variable, e.g. by comparison with a predetermined threshold value.

The above-described characteristics, features and advantages of this invention, as well as the manner in which these are realized, will become more clearly and easily intelligible in connection with the following schematic description of an exemplary embodiment which is explained in more detail with reference to the drawings.

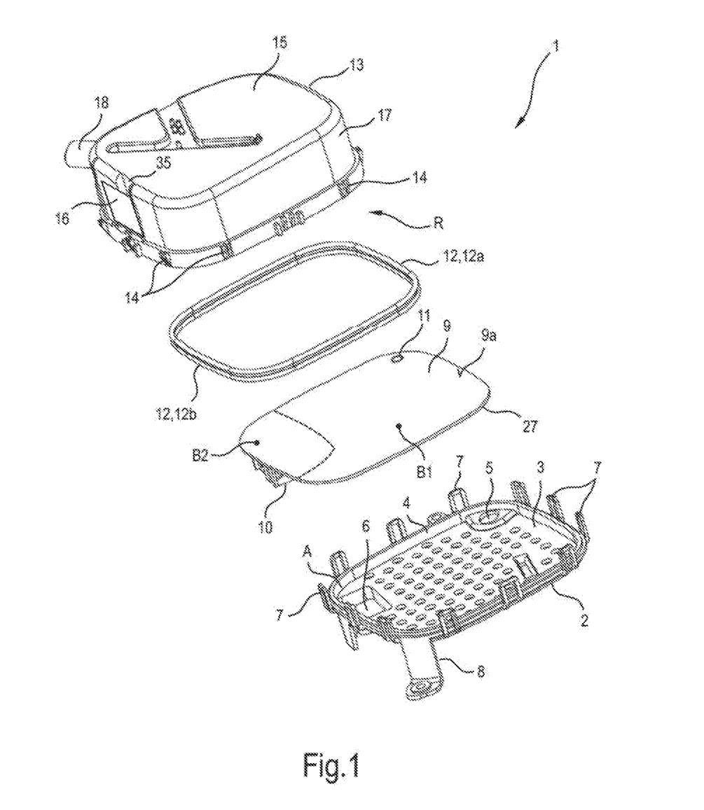

FIG. 1 shows an oblique view of an inventive evaporator in an oblique representation;

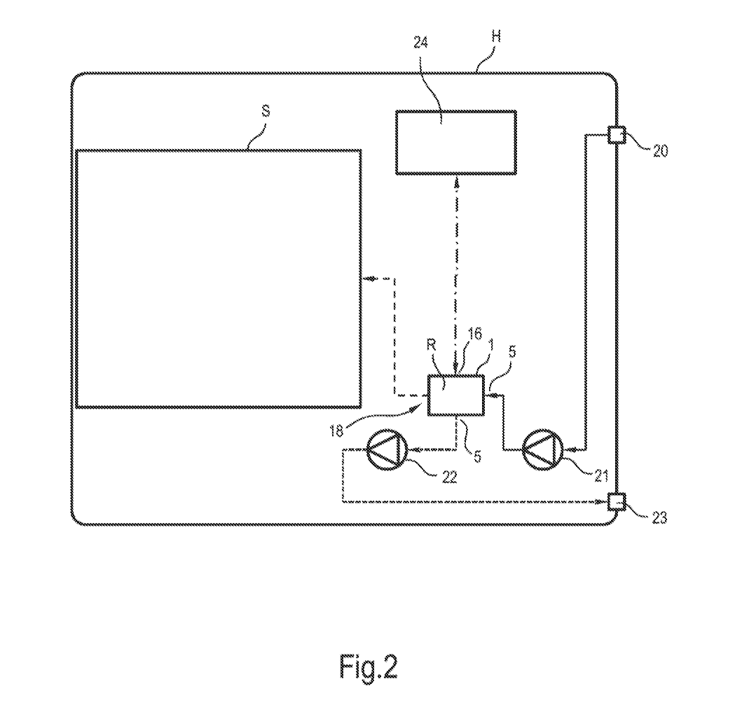

FIG. 2 shows a side view of a household appliance with the evaporator in a sectional representation; and

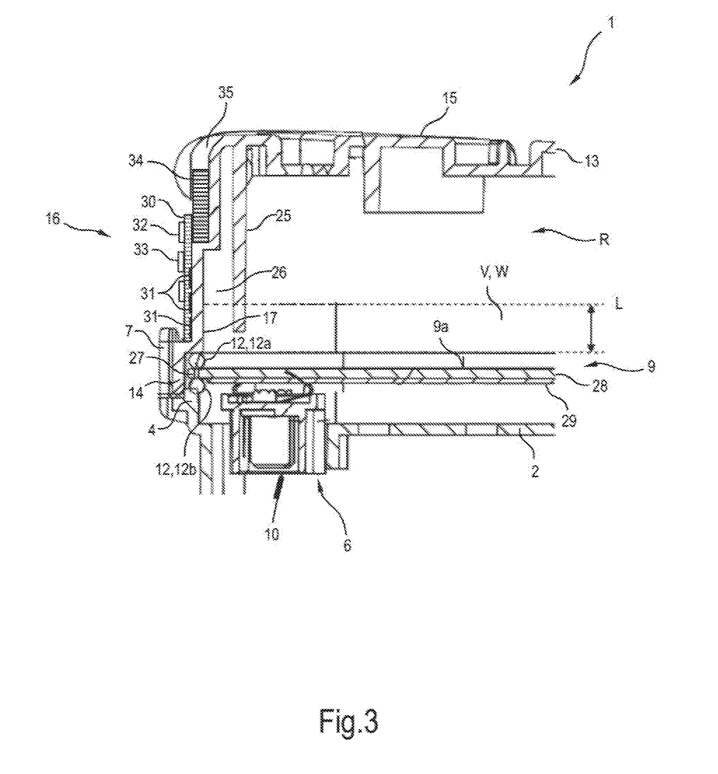

FIG. 3 shows a side view of a cutout from the assembled evaporator in a sectional representation.

FIG. 1 shows an oblique view of an evaporator 1 in an exploded representation, which is provided e.g. for use in a household steam cooking appliance H (see FIG. 2), e.g. in a stand-alone steam cooker or a baking oven with steam cooking function.

The evaporator 1 has a bottom piece 2 with a floor-side area 3 and an edge 4 which runs around the front side and connects thereto. The floor-side area 3 here has a flat basic form for instance with a rectangular outer contour A with rounded edges. At least two openings, here comprising a water throughput opening 5 and a through opening 6 for feeding through an electrical connection, are disposed in the floor-side area 3 for instance. A number of resilient locking latches 7 stand upright from the edge 4. Moreover, at least one fastening latch 8 extends in the rear direction, for instance to be screwed to the household steam cooking appliance H.

The floor-side area 3 is completely covered on the inside and sealed from an electrically operated large-surface heating element 9. The large-surface heating element 9 has an electrical connection 10 on its rear face, which protrudes through the through opening 6. The large-surface heating element 9 also has a hole 11, which is congruent with the water throughput opening 5. Water W (see also FIG. 3) can be filled and discharged through the hole 11 and the water throughput opening 5.

The large-surface heating element 9 can be heated up in a planar manner and may, to this end, have an electrically conductive front side 9a which faces the liquid. The large-surface heating element 9 can also have an (e.g. internal) layer, which is electrically conducting if a predetermined limit temperature is exceeded (see Fig. above). A significant change in the electrical conductivity or the electrical resistance or a current which can be conducted through this layer indicates here that the limit temperature has been reached and overheating has thus also occurred. The limit temperature may be approx. 200° C. for instance. The large-surface heating element 9 therefore optionally serves at the same time as an overheating detector for establishing its overheating.

The large-surface heating element 9 has a non-angular outer contour in the top view onto its front side 9a, namely that of a rectangle with circular rounded corners. A narrow side edge 27 of the large-surface heating element 9 runs around or in a closed manner along this outer contour.

The large-surface heating element 9 has a heatable or heated sub area or a heated zone B1 and an unheated sub area or an unheated zone B2. While at least one heating conductor (e.g. meander-shaped) is positioned in the heated zone B1 for instance, this is missing in the unheated zone B2. In particular, the water W may as a result be significantly agitated in the heated zone B1, possibly even boil, while the water W or its free surface remains comparatively still in the unheated zone B2. Here the unheated zone B2 takes up a corner area of the large-surface heating element 9.

The large-surface heating element 9 and the cover 13 together form a receiving space R for the water W. The large-surface heating element 9 here forms a floor or a floor-side wall of the receiving space R.

An arched or shell-like cover piece 13 rests on the bottom piece 2 by way of a peripheral seal 12. The cover piece 13 has a number of catch tappets 14 on the outside, which are provided for engagement with the locking latches 7 and permit a simple locking connection between the bottom piece 2 and the cover piece 13.

A capacitative fill level sensor 16 for determining a fill level L (see also FIG. 3) is arranged on the outside on a side wall of the cover piece 13. The evaporator 1 is filled with a corresponding volume V of water W when the fill level L is reached.

A steam outlet 18 is disposed on a peripheral side wall 17 of the cover 13 in the vicinity of the top wall 15. The steam outlet 18 embodied by way of example in the manner of supports may be connected e.g. to a pipe for guiding the steam generated by the evaporator in the food treatment chamber S of the household steam cooking appliance H. The steam outlet 18 is arranged above the unheated zone B2 so that small water droplets generated by the agitated water in the heated zone B1 cannot be carried along with the flow of steam. This improves the steam quality. The fewer water droplets there are in the flow of steam, the higher its energy content and thus the efficiency. Moreover, this prevents the food in the food treatment chamber S from being damaged by the water droplets.

FIG. 2 shows a sectional representation of a side view of a household steam cooking appliance H with the evaporator 1 from FIG. 1 in. The household steam cooking appliance H has a fresh-water connection 20, which is connected to the water throughput opening 5 of the evaporator 1 by way of a filling pump 21 serving as a filling facility. The evaporator 1 is also connected with its water throughput opening 5 by way of a drain pump 22 which serves as a drain facility to a waste water connection 23 of the evaporator 1. Operation of the filling pump 21 and the drain pump 22 is controlled by way of a control facility 24. The control facility 24 may control the operation of the large-surface heating element 9 of the evaporator 1.

The control facility 24 may also be connected to the fill level sensor 16, in order e.g. to control the filling pump 21 and/or the large-surface heating element 9 on the basis of a value of a fill level L which is sensed by means of the fill level sensor 16.

The control facility 24 may be a central control facility of the household steam cooking appliance H for instance, which controls even more functions for instance e.g. at least one heating facility (see Fig. above) for heating the food treatment chamber S.

The water throughput opening 5 is embodied here in the form of two spatially separated water inlet or water outlet openings, but may, as in FIG. 1, be a shared water throughput opening (i.e. a combined water inlet and water outlet opening).

During operation of the evaporator 1 for steam-treating food, steam is admitted into the, if applicable, warmed steam treatment chamber S of the household steam cooking appliance H by way of the steam outlet 18 of the evaporator 1. To this end in one development water is firstly pumped into the receiving space R by means of the filling pump 21, until a predetermined fill level L shown by way of example in FIG. 3 is reached. Once the predetermined fill level L is reached, the filling pump 21 is stopped immediately or after a defined time lag (e.g. between 1 sec and 3 sec). The then activated large-surface heating element 9 allows the water to evaporate so that the water level drops. Once the water level has dropped to below the fill level L, the control facility 24 once again activates the filling pump 21 for filling the receiving space R with water etc. Typically the filling pump 21 is activated twice to three times for in each case five to seven seconds per minute. The design of the evaporator 1 permits a particularly rapid and delay-free evaporation of the filled water, for instance by the large-scale introduction of energy by means of the large-surface heating element 9 and a minimal predetermined fill level L in the range of millimeters, e.g. between eight and ten millimeters, preferably nine millimeters.

As shown further in FIG. 3, a separating wall 25 protrudes from the top wall 15 of the cover 13 internally into the receiving space R. The separating wall 25 protrudes above the unheated area B2 at a lateral distance from the heated area B1 vertically downwards in the direction of the large-surface heating element 9. The separating wall 25 allows a gap relative to the large-surface heating element 9 in order to ensure an exchange of water W between a chamber 26 formed by the separating wall 25 and the remaining receiving space R. The chamber 26 is disposed entirely above the heated area B1 and is also delimited by the area of the side wall of the cover 13 on the exterior of which the fill level sensor 16 is disposed. The water W disposed in this chamber 26 represents a still area of the overall volume V.

The fill level sensor 16 is thus disposed (separated by the side wall 17) on the chamber 26 and thus also on or in the vicinity of the unheated zone B2 or the still area of the water W.

Here the fill level sensor 16 has a circuit board 30, which rests with a first side in a planar manner on the side wall 17. On this first side the circuit board 30 is populated with a number of measuring elements in the form of electrodes 31, which can serve as plates or plate areas of a capacitor for instance. On the second side facing away from the housing 13, the circuit board 30 is equipped with a driver and/or evaluation circuit 32, e.g. a microcontroller.

Also arranged on the second side is a temperature sensor 33, e.g. an NTC sensor, which senses the temperature of the circuit board 30. Therefore during a signal evaluation for instance, temperature-dependent component properties of the fill level sensor 16 and/or a temperature dependency of the permittivity of the water W can be taken into account and at least partially compensated. The temperature of the water W can be correlated here for instance by a characteristic curve, a simple offset etc. with the temperature of the circuit board 30.

The temperature sensor 33 may also be connected to the control facility 24, so that this can set the temperature of the water W, e.g. in order to be able to keep a cleaning and/or descaling fluid within a predetermined temperature range.

For communication of the fill level sensor 16 with another component of the household steam cooking appliance H, e.g. the control facility 24, the circuit board 30 may have a communication interface 34, e.g. a plug or a radio interface. Therefore the fill level sensor 16 can transmit e.g. fill level and/or temperature values to the control facility 24. The communication interface 34 is admitted into a receiving recess 35 in the cover 13 and may thus also serve as a holding element.

FIG. 3 also shows more precisely the design of the large-surface heating element 9 and the arrangement of the seal 12: The large-surface heating element 8 has a carrier plate 28 on the top side, which forms the floor-side wall of the receiving space R and its front side 9a points into the receiving space R. The carrier plate 28 may be a steel sheet for instance, the front side 9a of which is uncoated or scaled for instance. The carrier plate 28 may, in particular, have a thickness of between one and two millimeters, but it is not restricted thereto. A number of thick-film heating conductors 29 are disposed on a rear of the carrier plate 28, namely separated from the carrier plate 28 by an insulation layer (see Fig. above). The thick-film heating conductor 29 does not extend below the unheated zone B2. A cover layer (see Fig. above) may also be applied from below onto the thick-film heating conductor 29 and if necessary the exposed areas of the insulation layer. Such a large-surface heating element 9 may in particular have a thickness of between one and two millimeters, but it is however not restricted thereto. For instance, two thick-film heating conductors 29 may be available, which can be operated individually or together with a nominal output of 400 W or 800 W. Here both thick-film heating conductors 29 may practically completely heat the heated zone B1. The two thick-film heating conductors 29 may be intertwined into one another in a meander-shaped manner for instance. The seal 12 is embodied as a double seal with an upper sealing element 12a and a lower sealing element 12b which is identical thereto. The sealing elements 12a and 12b run analogously to the side edge 27. The lower sealing element 12b seals a gap between the bottom piece 2, especially its edge 4, and a rear face of the carrier plate 28. The upper sealing element 12a seals a gap between the front side 9a of the carrier plate 28 and the cover piece 13. In particular, the upper sealing element 12a prevents liquid from leaving the receiving space R and reaching the bottom piece 2. While the cover piece 13, the carrier plate 28 and the upper sealing element 12a therefore come into contact with the liquid and should therefore be embodied as foodsafe, the bottom piece 2 does not need to be embodied as foodsafe. The bottom piece 2 may in particular consist of a flame-retardant plastic, which has a higher elasticity than the foodsafe plastic of the cover piece 13. The side edge 27 is embodied convex or curved in the cross-section. The two sealing elements 12a and 12b of the seal 12 rest on the convex side edge 27. On account of the convex form, the cover piece 13 and the side edge 27 form a holding area for the upper sealing element 12a, as a result of which the upper sealing element 12a can be held in a slightly tightened manner

The present invention is of course not restricted to the exemplary embodiment shown.

In general, “a”, ^{one} etc. can be regarded as a singular or a plurality, in particular in the sense of ^{at} least one or one or more etc., as long as this is not explicitly excluded, e.g. by the expression “precisely one” etc.

In addition, a given number can include precisely the number given and also a conventional tolerance range, as long as this is not explicitly excluded.

### LIST OF REFERENCE CHARACTERS

1 Evaporator

2 Bottom piece of the evaporator

3 Floor-side area

4 Edge

5 Water throughput opening

6 Through opening

7 Locking latch

8 Fastening latch

9 Large-surface heating element

9a Surface of the large-surface heating element

10 Electrical connection

11 Hole

12 Seal

12a Upper sealing element

12b Lower sealing element

13 Cover piece

14 Catch tappet

15 Top-side wall of the cover

16 Capacitative fill level sensor

17 Side wall of the cover

18 Steam outlet

20 Fresh-water connection

21 Filling pump

22 Drain pump

23 Waste water connection

24 Control facility

25 Separating wall

26 Chamber

27 Side edge of the large-surface heating element

28 Carrier plate

29 Thick-film heating conductor

30 Circuit board

31 Electrode

32 Evaluation facility

33 Temperature sensor

34 Communication interface

35 Receiving recess

A Outer contour

B1 Heated zone of the large-surface heating element

B1 Unheated zone of the large-surface heating element

H Household steam appliance

L Fill level

R Receiving space

S Food treatment space

V Volume

W Water

1-12 (canceled)

13. An evaporator for a household appliance, comprising:
a housing wall configured to delimit a receiving space for a liquid to be evaporated;
an electrical heating unit for heating the liquid; and
a fill level sensor arranged on an exterior face of the housing wall and configured to determine a fill level of the liquid in the receiving space, said fill level sensor operating in a contactless manner and generating an electromagnetic field in the receiving space.

14. The evaporator of claim 13, wherein the fill level sensor is a capacitative fill level sensor.

15. The evaporator of claim 13, wherein the fill level sensor is an inductive fill level sensor.

16. The evaporator of claim 13, wherein the electrical heating unit is a large-surface heating element representing a floor of the receiving space, said large-surface heating element having an unheated zone, with said fill level sensor being arranged on the unheated zone.

17. The evaporator of claim 16, further comprising a separating wall extending into a volume above the unheated zone of the large-surface heating element which volume can be filled by the liquid.

18. The evaporator of claim 17, further comprising a ceiling, said separating wall extending from the ceiling into the volume.

19. The evaporator of claim 17, wherein the separating wall is configured to form a chamber above the unheated zone, said chamber being open on a floor side and fluidically communicating with the receiving space.

20. The evaporator of claim 13, further comprising a temperature sensor arranged on the fill level sensor.

21. The evaporator of claim 20, further comprising an evaluation facility configured to evaluate a sensor signal of the fill level sensor, said temperature sensor being connected with the evaluation facility.

22. The evaporator of claim 20, further comprising a temperature setting facility configured to set a temperature of the liquid and/or the heating unit, said temperature sensor being connected with the temperature setting facility.

23. The evaporator of claim 13 for installation in a cooking appliance as the household appliance.

24. A household appliance, comprising an evaporator which includes a housing wall configured to delimit a receiving space for a liquid to be evaporated, an electrical heating unit for heating the liquid, and a fill level sensor arranged on an exterior face of the housing wall and configured to determine a fill level of the liquid in the receiving space, said fill level sensor operating in a contactless manner and generating an electromagnetic field in the receiving space.

25. The household appliance of claim 24, wherein the fill level sensor is a capacitative fill level sensor or an inductive fill level sensor.

26. The household appliance of claim 24, wherein the electrical heating unit is a large-surface heating element representing a floor of the receiving space, said large-surface heating element having an unheated zone, with said fill level sensor being arranged on the unheated zone.

27. The household appliance of claim 26, further comprising a separating wall extending into a volume above the unheated zone of the large-surface heating element which volume can be filled by the liquid.

28. The household appliance of claim 27, further comprising a ceiling, said separating wall extending from the ceiling into the volume.

29. The household appliance of claim 27, wherein the separating wall is configured to form a chamber above the unheated zone, said chamber being open on a floor side and fluidically communicating with the receiving space.

30. The household appliance of claim 24, wherein the evaporator includes a temperature sensor arranged on the fill level sensor.

31. The household appliance of claim 30, wherein the evaporator includes an evaluation facility configured to evaluate a sensor signal of the fill level sensor, said temperature sensor being connected with the evaluation facility.

32. The household appliance of claim 30, wherein the evaporator includes a temperature setting facility configured to set a temperature of the liquid and/or the heating unit, said temperature sensor being connected with the temperature setting facility.
